(19) United States
(12) Patent Application Publication
(10) Pub. No.: US 2009/0165300 A1
(43) Pub. Date: Jul. 2, 2009

(54) MANUFACTURING METHOD OF A LIQUID EJECTING HEAD AND A LIQUID EJECTING APPARATUS WITH SAID HEAD

(75) Inventor: Atsushi Furuhata, Matsumoto-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/338,929

(22) Filed: Dec. 18, 2008

(30) Foreign Application Priority Data
Dec. 20, 2007 (JP) 2007-329089

(51) Int. Cl. B23P 17/00

(52) U.S. Cl. 29/890.1

(57) ABSTRACT

A liquid ejecting head which has a first substrate and a second substrate having a burr resulting from press working formed at one side thereof is manufactured by the first joining step of joining the first substrate to the non-burred other side of the second substrate and the second joining step of disposing a sheet for protecting the shape of the burr on one side of the second substrate and joining the second substrate and the first substrate joined in the first step by holding between pressing members in such a manner that the sheet is in contact with the burr.

### CROSS REFERENCES TO RELATED APPLICATIONS

The present invention claims the priority of Japanese Patent Application No. 2007-329089 filed in the Japanese Patent Office on Dec. 20, 2007, the entire contents of which are incorporated herein by reference.

### BACKGROUND OF THE INVENTION

1. Field of the Invention

The present invention relates to a manufacturing method of a liquid ejecting head and to a liquid ejecting apparatus provided with a head manufactured by such a manufacturing method.

2. Description of the Related Art

As a representative example of a liquid ejecting head, an ink jet recording head, for example, that ejects ink droplets by utilizing a pressure resulting from displacement of a piezoelectric element is disclosed in, for example, Japanese Unexamined Patent Application Publication No. 2004-74740. A well known ink jet recording head includes a passage forming substrate having a pressure generating chamber, a vibration plate that generates a pressure change in the pressure generating chamber, and a nozzle plate joined to the passage forming substrate in a region opposite the vibration plate. Also, the ink jet recording head has a piezoelectric element (piezoelectric vibrator) housed in a housing in a case member (case head), the piezoelectric element being secured to a support substrate, and causes the piezoelectric element to vibrate, thereby ejecting ink through nozzle openings in the nozzle plate.

To manufacture an ink jet recording head, a nozzle plate and a member (vibration plate member) constituting a vibration plate are disposed either side of a passage forming substrate, and are held by being subjected to pressure with a metal joining jig, thereby joining the vibration plate member and the nozzle plate to either side of the passage forming substrate to form a joined body. Also, a case head having a piezoelectric vibrator or the like is disposed on the vibration plate member side of the joined body, and is subjected to pressure with a metal joining jig, thereby joining the case head to the joined body. The nozzle plate of the ink jet recording head is a metal plate having a large number of nozzle holes, and is formed by means of press working. This causes burrs to inevitably occur at the peripheral edge of the nozzle plate during press working. If an attempt is made to fabricate the joined body while burrs are present in the nozzle plate, a metal joining jig presses against the burrs, which causes greater pressing force to be exerted on the peripheral edge of the nozzle plate, raising concerns about unsatisfactory contact between the center portion of the nozzle plate and the passage forming substrate. Although efforts have been made to minimize the size of the burrs by making adjustment to the press working in order to give a uniform contact between the nozzle plate and the passage forming substrate, there are still concerns about unsatisfactory contact between the center portion of the nozzle plate and the passage forming substrate.

### SUMMARY OF THE INVENTION

The present invention has been achieved to solve at least some of the above-described drawbacks and can be realized as an embodiment described below.

An embodiment to which the present invention is applicable is a manufacturing method of a liquid ejecting recording head that includes a first substrate having a pressure generating chamber and a second substrate having a nozzle opening, the second substrate having a burr resulting from press working formed on one side thereof, comprising the first joining step of joining the first substrate to the other non-burred side of the second substrate and the second joining step of disposing a sheet material for protecting the shape of the burr on one side of the second substrate and joining the second substrate and the first substrate joined in the first step by holding between pressing members in such a manner that the sheet material is in contact with the burr.

The above as well as additional features and objectives of the present invention will become apparent in the following description in conjunction with the accompanying drawings.

### BRIEF DESCRIPTION OF THE DRAWINGS

For a more complete understanding of the present invention and the advantages thereof, reference is now made to the following descriptions in conjunction with the accompanying drawings.

FIG. 1 is a cross-sectional view of a recording head according to an embodiment of the present invention.

FIG. 2 is a view of section taken along the line II-II of FIG. 1.

FIG. 3 is an external view of a piezoelectric element unit.

FIG. 4 is a cross-sectional view of a passage forming unit in unassembled form.

FIG. 5 is a cross-sectional view of an ink jet recording head in unassembled form.

FIG. 6 is a schematic diagram illustrative of the manufacturing method according to an embodiment of the present invention.

FIG. 7 is a schematic diagram of an ink jet recording head in unassembled form.

FIG. 8 is a schematic diagram depicting how peeling off occurs in a nozzle plate.

### DESCRIPTION OF THE PREFERRED EMBODIMENTS

At least the following will become apparent from the following descriptions and the accompanying drawings.

An embodiment to which the present invention is applicable is a manufacturing method of a liquid ejecting recording head that includes a first substrate having a pressure generating chamber and a second substrate having a nozzle openings, the second substrate having a burr resulting from press working formed on one side thereof, comprising a first joining step of joining the first substrate to the other non-burred side of the second substrate and a second joining step of disposing a sheet material for protecting the shape of the burr on the one side of the second substrate and joining the second substrate and the first substrate joined in the first step to the sheet material by holding the first substrate, the second substrate, and the sheet material between pressing members in such a manner that the sheet material is in contact with the burr.

According to the manufacturing method, the first substrate is temporarily joined to the second substrate such that the burr, resulting from the press working, at the peripheral edge of the first substrate is oriented in the direction away from the second substrate, and then is permanently joined such that the burr is in contact with the sheet material. This causes a joining jig to come into contact with the entire surface of the second substrate in a uniform manner, thereby allowing the second substrate to be uniformly joined to the first substrate even if the second substrate has a burr formed at the peripheral edge thereof.

After the second substrate is joined to the first substrate to form a joined body, a case member is disposed on one side of the first substrate, which is opposite to the other side on which the first and second substrates are joined. Then the joined body and the case member are joined by subjecting to pressure with the joining jig.

When an attempt is made to join the joined body to the case member, this method prevents the peripheral edge of the second substrate from exerting increased pressing force on the first substrate even if the second substrate has a burr formed at the peripheral edge thereof, thereby allowing uniform joining to be achieved when pressurization is performed with the joining jig for joining.

The sheet material is characterized by being a sheet made of fluorine resin (polytetrafluoroethylene (PTFE)) consisting of fluorine and carbon. With this arrangement, bringing the burr into contact with the fluorine resin sheet allows the second substrate to be joined to the first substrate in a uniform manner.

In this way, a liquid ejecting apparatus with a liquid ejecting head manufactured by the above described manufacturing method is provided. Use of this liquid ejecting apparatus ensures that highly reliable apparatuses are provided.

A preferred embodiment of the present invention will now be described below with reference to the accompanying drawings. The embodiment to be described below is described as one example of the present invention, and not all of the components to be presented below constitute the essential components of the present invention.

### BEST MODE FOR CARRYING OUT THE INVENTION

An embodiment of the present invention is described below on the basis of the accompanying drawings.

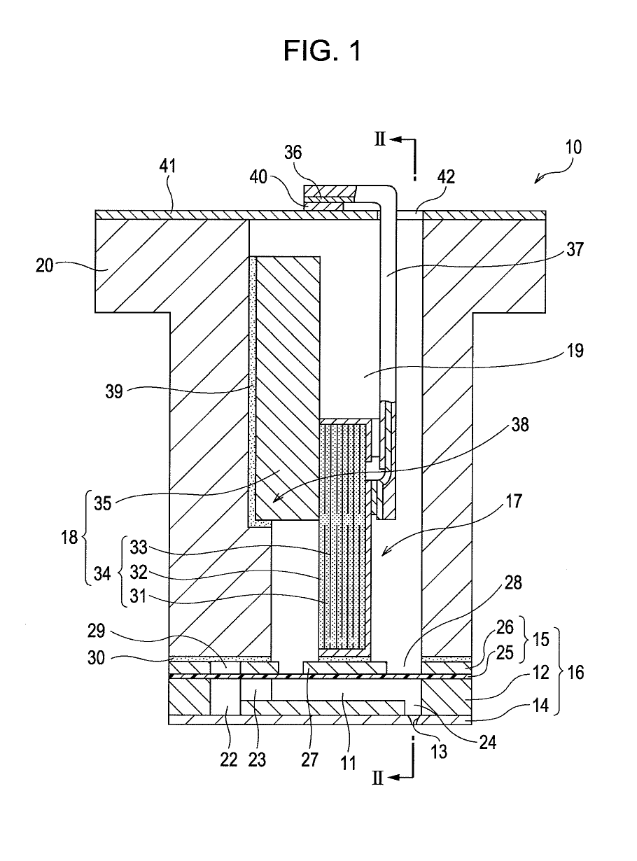

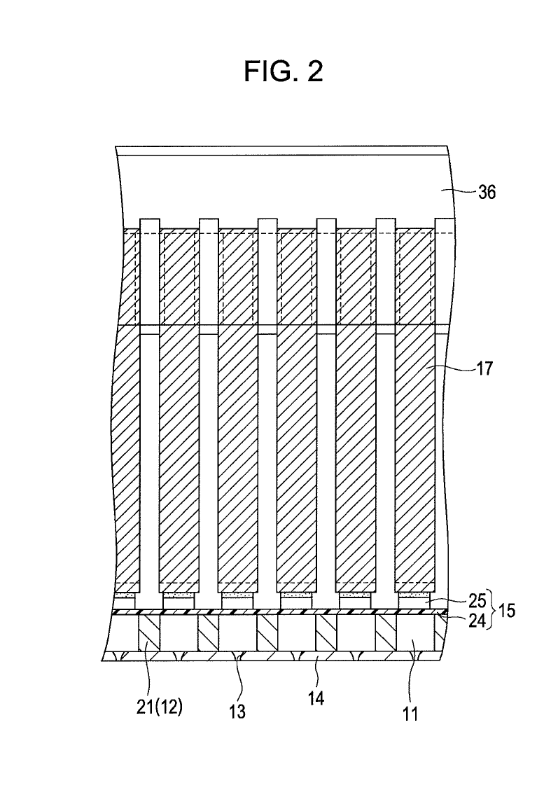

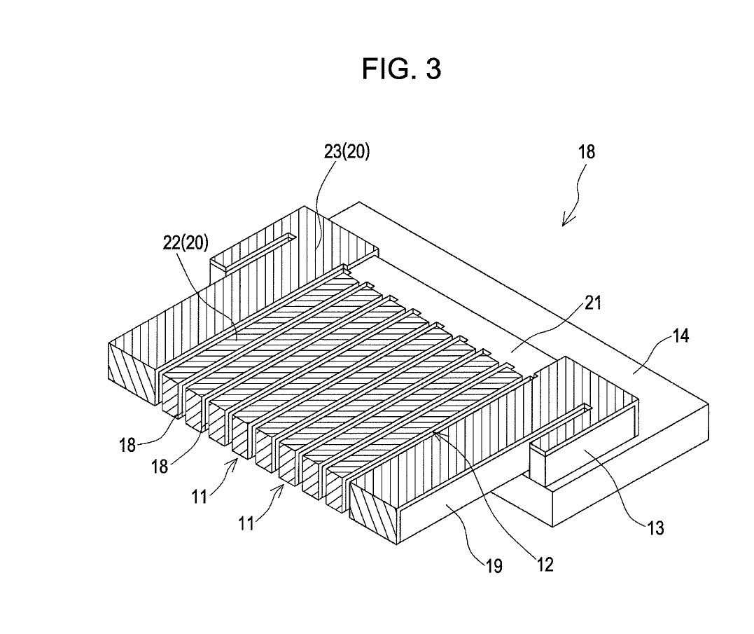

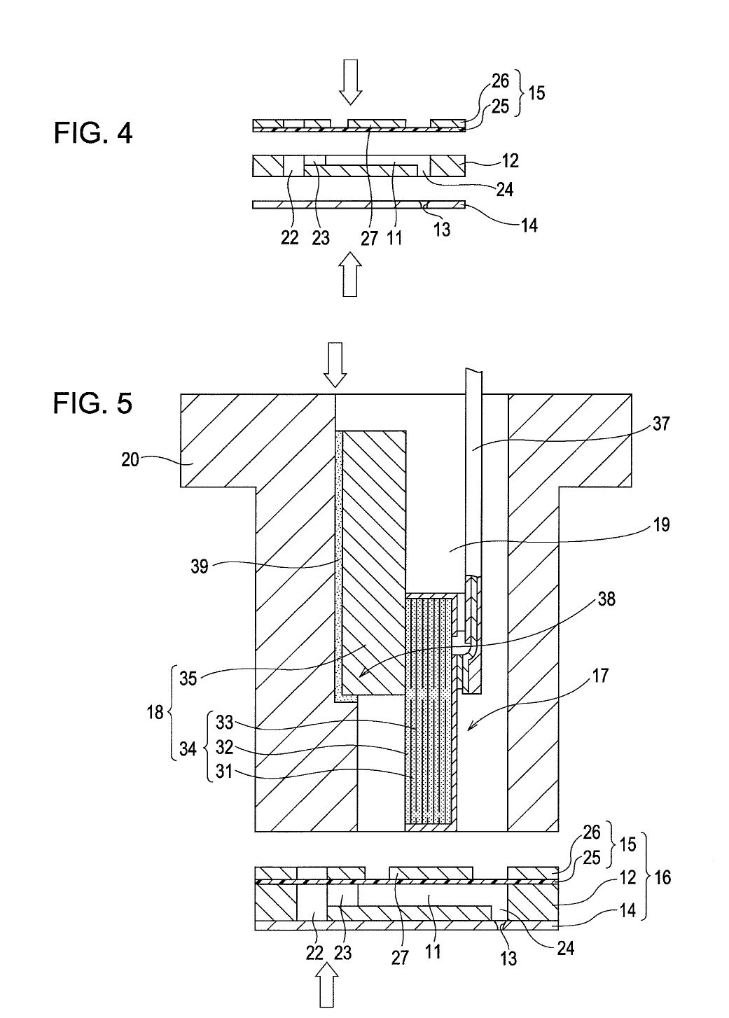

FIG. 1 is a cross-sectional view outlining an ink jet recording head as an example of a liquid ejecting head to which the manufacturing method according to an embodiment of the present invention is applied. FIG. 2 is a sectional view taken along the line II-II of FIG. 1. FIG. 3 is an external view of a piezoelectric element unit. FIG. 4 is a cross-sectional view of a passage forming unit in unassembled form. FIG. 5 is a cross-sectional view of an ink jet recording head in unassembled form.

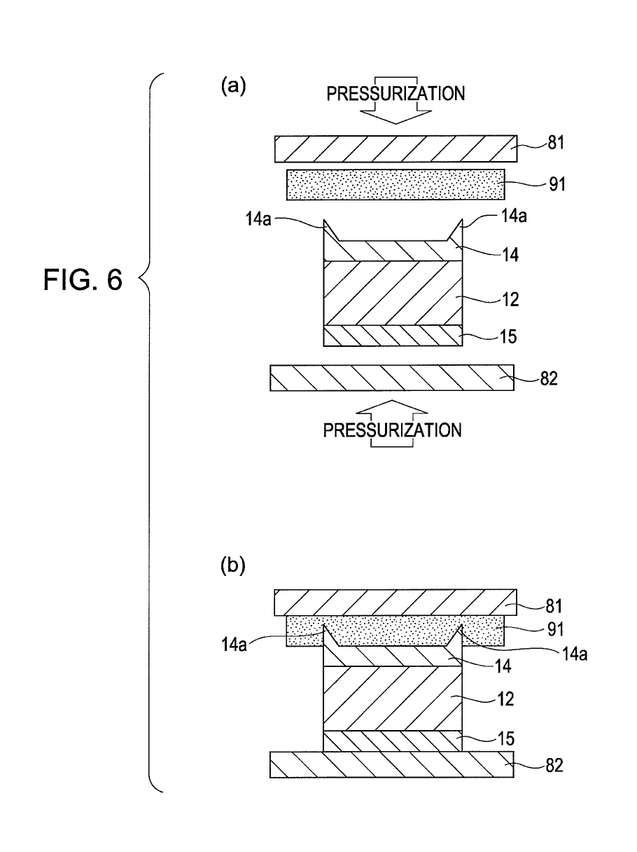

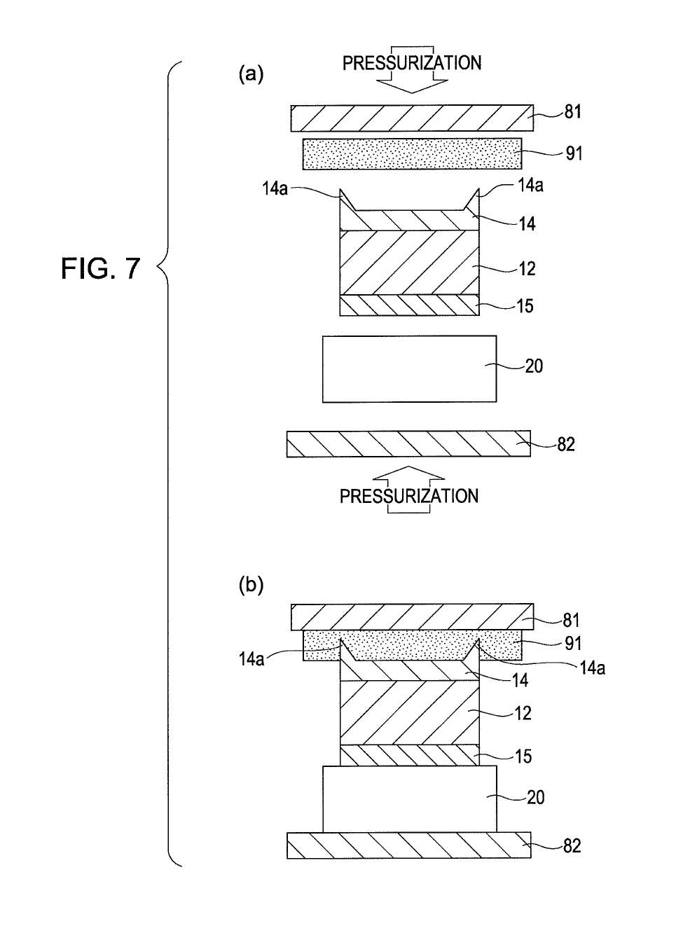

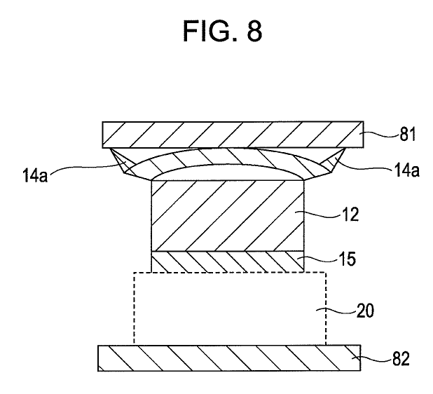

Also, FIG. 6 is a schematic diagram illustrating the passage forming unit, in unassembled form, which has the nozzle plate joining structure according to an embodiment of the present invention. FIG. 7 is a schematic diagram illustrating the ink jet recording head, in unassembled form, which has the nozzle plate joining structure according to an embodiment of the present invention. FIG. 8 is a schematic diagram depicting how peeling occurs in the nozzle plate.

An ink jet recording head will now be described with reference to FIGS. 1 through 5.

As shown in FIGS. 1 through 3, the ink jet recording head 10 includes a passage forming substrate 12 having a plurality of pressure generating chambers 11. The passage forming substrate 12 includes a nozzle plate 14 made of metal (for example, stainless steel plate: SUS) joined to one side thereof (bottom surface in the figure). The nozzle plate 14 includes a plurality of nozzle openings 13 communicating with the pressure generating chambers. The passage forming substrate 12 opposing the nozzle plate 14 includes a vibration plate 15 joined thereto with an adhesive or a heat welding film, which causes the pressure generating chambers to be sealed by the vibration plate 15. The passage forming substrate 12 having the nozzle plate 14 and the vibration plate 15 joined thereto constitutes a passage forming unit 16.

The vibration plate 15 is provided in a region corresponding to the pressure generating chamber 11 with a piezoelectric element unit 18 thereon. The piezoelectric element unit 18 includes a piezoelectric element 17. The vibration plate 15 includes a case head 20 secured thereto as a case member. The case head 20 includes a housing 19 formed therein for housing the piezoelectric element unit 18.

The passage forming substrate 12 includes the plurality of pressure generating chambers 11 disposed in parallel on the surface layer thereof, the pressure generating chambers 11 being defined by bulkheads 21. Reservoirs 22 are formed on the external sides of a row of the pressure generating chambers 11, respectively, such that they penetrate the passage forming substrate 12 in the thickwise direction. Ink is supplied to the pressure generating chambers 11 through the reservoirs 22.

The pressure generating chamber 11 communicates with the reservoir 22 through an ink supply passage 23. The ink supply passage 23 is narrower than the pressure generating chamber 11. The fact that the ink supply passage 23 is narrower than the pressure generating chamber 11 causes the ink flowing into the pressure generating chamber 11 from the reservoir 22 to maintain a constant flow resistance.

The pressure generating chamber 11 includes a nozzle communicating hole 24 formed at the end thereof opposite to the end with the reservoir 22, and the nozzle communicating hole 24 runs through the passage forming substrate 12. The passage forming substrate 12 is made of, for example, a silicon single crystal substrate. The pressure generating chamber 11 or the like is formed by etching the passage forming substrate 12. The nozzle communicating hole 24 causes the pressure generating chamber 11 to communicate with the nozzle opening 13 in the nozzle plate 14.

The vibration plate 15 that seals the pressure generating chamber 11 is composed of a composite plate of an elastic film 25 and a support plate 26, and the elastic film 25 is joined to the passage forming substrate 12. The elastic film 25 consists of a film of elastic material (for example, polyphenylene sulfide (PPS) film having a thickness of several tens of micrometers) such as a resin film, while the support plate 26 consists of a stainless steel plate (SUS) having a thickness of several tens of micrometers.

The vibration plate 15 is provided in a region opposite the pressure generating chamber 11 with an island 27 with which the piezoelectric element 17 is in contact at the tip thereof. In other words, the vibration plate 15 includes thin wall portions 28 formed thereon by etching in regions opposite the peripheral portions of the pressure generating chamber 11, the thin wall portions 28 being thinner than other regions, in such a manner that the island 17 is formed on the inside of the thin wall portions 28. The piezoelectric element 17 is joined at the tip of the active region thereof to the island 17 with an adhesive 30.

The vibration plate 15 is also provided in a region opposite the reservoir 22 with a compliance portion 29. The compliance portion 29 is formed by removing an appropriate portion from the support plate 26 by etching, like the thin wall portion 28. Therefore, the compliance portion is defined only by the elastic film 25. When a pressure change occurs in the reservoir 22, the elastic film 25 in the compliance portion 29 deforms to absorb such a pressure change, allowing a constant pressure to be maintained in the reservoir 22.

The piezoelectric element 17 is a pressure generating unit that generates a pressure in the pressure generating chamber 11 for ejecting ink droplets, and is formed in one piezoelectric element unit 18 in an integral manner. A piezoelectric element forming member 34 constituting the piezoelectric element unit 18 is formed by laminating electrode forming materials 32, 33 on either side of a piezoelectric material 31. The piezoelectric element forming member 34 is divided in a comb-like shape to form the piezoelectric elements 17 respectively corresponding to the pressure generating chambers 11 (see FIG. 3).

The piezoelectric element 17 (piezoelectric element forming member 34) is secured at one side of an inactive region at the base end thereof to a fixed substrate 35, the inactive region not contributing to vibration, while the piezoelectric element 17 is connected at the other side close to the base end to a circuit substrate 37. The circuit substrate 37 is provided with a lead 36 through which a signal is supplied to the piezoelectric element 17 for its activation. The piezoelectric element unit 18 consists of the piezoelectric element 17 (piezoelectric element forming member 34), the fixed substrate 35, and the circuit substrate 37.

Meanwhile, the case head 20 is joined to the top surface (top surface of the support plate 26) of the vibration plate 15 with an adhesive 30, and the case head 20 includes the housing 19 formed therein for housing the piezoelectric element unit 18. In the piezoelectric element unit 18 housed in the housing 19, the piezoelectric element 17 is joined at the tip thereof to the island 27 on the vibration plate 15, while the fixed substrate 35 is joined to a step 38 formed on the case head 20 with an adhesive 39.

A wiring substrate 41 is secured to the top surface of the case head 20, and the wiring substrate 41 is provided with a plurality of conductive pads 40. Each of these conductive pads 40 is connected to the corresponding lead 36 in the wiring circuit 37. The housing 19 in the case head 20 is configured to be plugged with the wiring substrate 41. The wiring substrate 41 includes a slit-shaped opening 42 formed in a region opposite the housing 19 in the case head 20, and the circuit substrate 37 extends to the outside of the housing 19 through the opening 42.

The circuit substrate 37 constituting the piezoelectric element unit 18 consists of, for example, a chip-on-film (COF) having a driving IC (not shown) mounted thereon for driving the piezoelectric element 17. The lead 36 in the circuit substrate 37 is connected at one end thereof to the electrode forming materials 32, 33 at the base end with solder, anisotropic conductive material, or the like, the electrode forming materials 32, 33 constituting the piezoelectric element 17. The lead 36 is joined at the other end to each of the conductive pads 40 on the wiring substrate 41. In other words, the circuit substrate 37 is taken to the outside of the housing 19 through the opening 42 in the wiring substrate 41, and the lead 36 is connected to each of the conductive pads 40 on the wiring substrate 41 while the other end of the circuit substrate 37 is bent and laid along the surface of the wiring substrate 41.

When attempting to eject ink droplets, the above-mentioned ink jet recording head 10 deforms the piezoelectric element 17 and the vibration plate 15, which causes a volume change in the pressure generating chamber 11, thereby ejecting ink droplets through a predetermined nozzle opening 13. When ink is supplied to the reservoir 22 through an ink cartridge (not shown), the ink is distributed to the pressure generating chamber 11 through the ink supply passage 23. Namely, the application of a voltage to the piezoelectric element 17 causes the piezoelectric element 17 to contract, thereby deforming both the vibration plate 15 and the piezoelectric element 17 and, as a result, expanding the volumetric capacity of the pressure generating chamber 11, which causes ink to be drawn into the pressure generating chamber 11.

After the chamber is filled up with ink to the nozzle opening 13, the voltage application to the electrode forming materials 32, 33 of the piezoelectric element 17 is withdrawn in accordance with a recording signal supplied through the wiring substrate. This causes the piezoelectric element 17 to extend to its original state and also causes the vibration plate 15 to return to its original state. As a result, the volumetric capacity of the pressure generating chamber 11 contracts, which results in a pressure increase in the pressure generating chamber 11, thereby allowing ink droplets to be ejected through the nozzle opening 13.

A manufacturing method of a liquid ejecting head according to an embodiment of the present invention will be described on the basis of FIGS. 4 and 5.

As shown in FIG. 4, the nozzle plate 14 and the vibration plate 15 are disposed with the passage forming substrate 12 therebetween, and are held by using a joining jig (not shown). Such a joining jig is used to subject the nozzle plate 14, the passage forming substrate 12, and the vibration plate 15 to pressure, which causes the nozzle plate 14 and the vibration plate 15 to be joined to either side of the passage forming substrate 12, respectively, to form a passage forming unit 16 as a joined body.

As shown in FIG. 5, the case head 20 having the piezoelectric element unit 18 therein is disposed on the passage forming unit 16 at the side of vibration plate 15, which are held by using a joining jig (not shown). Such a joining jig is used to subject the case head 20 and the passage forming unit 16 to pressure, which causes the case head 20 to be joined to the passage forming unit 16 to form a major section of the ink jet recording head 10 (see FIG. 1).

A manufacturing method of a liquid ejecting head constituting the passage forming unit 16 is schematically described based on FIG. 6. FIG. 6 shows a schematic diagram with the nozzle plate 14 placed up.

The nozzle plate 14 undergoes a punching process associated with press working so that the nozzle plate 14 has a burr 14a resulting from such a process formed at the peripheral edge of one side thereof. Namely, such a punching process is carried out so that the burr 14a resulting from the punching process are directed toward the direction opposite to the passage forming substrate 12 (upward direction in the figure).

The passage forming substrate 12 is temporarily joined to the face (one face) having no burr 14a of the nozzle plate 14 (temporal joining process). Then a pair of metal plates 81, 82 as pressing members subject the nozzle plate 14, the passage forming substrate 12, and the vibration plate 15 to pressure.

A sheet 91 of fluorine resin (polytetrafluoroethylene (PTFE)) consisting of fluorine and carbon is placed between the metal plate 81 and the face (the other face) having the burr 14a of the nozzle plate 14. The sheet 91 protects the form of the burr 14a (see FIG. 6(a)). The sheet 91 comes into contact with the burr 14a of the nozzle plate 14 when the temporarily joined nozzle plate 14 and the passage forming substrate 12 (and the vibration plate 15) are subjected to pressure by a pair of the metal plates 81, 82.

The sheet material is not limited to fluorine resin, and other resin, such as PET, or a flexible material other than resin can be used as a sheet as long as they are soft enough to allow the burr 14a to be immersed in themselves when subjected to pressure. Also, the sheet 91 and the metal plate 81 can be integrated to form one piece.

With this arrangement, a pair of the metal plates 81, 82 subject the sheet 91, the nozzle plate 14, passage forming substrate 12, and the vibration plate 15 to pressure, thereby joining the nozzle plate 14 and vibration plate 15 to either side of the passage forming substrate 12 to form the passage forming unit 16 (see FIG. 6(b)). In other words, the nozzle plate 14 and the passage forming substrate 12, temporarily joined to each other, are held between the pressing members for permanent joining (permanent joining process).

In the manufacturing method described above, the burr 14a, created on the peripheral edge of the nozzle plate 14 during a pressing process, are oriented toward the metal plate 81, and the sheet 91 is placed between the metal plate 81 and the nozzle plate 14 in order to allow the burr 14a of the nozzle plate 14 to come into contact with the sheet 91 when subjected to pressure by a pair of the metal plates 81, 82, thereby enabling the nozzle plate 14 to come into contact with the metal plate 81 without suffering from the effect of the burr 14a when subjected to pressure for joining. Accordingly, the entire surface of the nozzle plate 14 is uniformly in contact with the metal plate 81, thereby enabling the nozzle plate 14 to be joined to the passage forming substrate 12 in a uniform manner even if the nozzle plate 14 has the burr 14a formed at the peripheral edge thereof.

As shown in FIG. 8, when the burr 14a at the peripheral edge of the nozzle plate 14 come into contact with the metal plate 81, the peripheral edge of the metal plate 81 presses against the burr 14a at the peripheral edge of the nozzle plate 14, which causes the nozzle plate 14 to bend due to greater pressing force exerted on the peripheral edge of the nozzle plate 14. For this, a satisfactory contact between the central portion of the nozzle plate 14 and the passage forming substrate 12 cannot be obtained.

In the manufacturing method according to the present invention, the burr 14a of the nozzle plate 14 contact the sheet 91, thereby allowing the burr 14a to be in uniform contact with the metal plate 81 even if the nozzle plate 14 has the burr 14a formed at the peripheral edge thereof. This prevents greater pressing force from being exerted on the peripheral edge of the nozzle plate 14, thereby allowing the nozzle plate 14 to be uniformly joined to the passage forming substrate 12 in a uniform manner.

After the passage forming unit 16 is formed, the case head 20 having the piezoelectric element unit 18 (see FIG. 1) therein is disposed on the side of the vibration plate 15, as shown in FIG. 7 (see FIG. 7(a)). Then, the passage forming unit 16 and the case head 20 are subjected to pressure with a pair of the metal plates 81, 82 to cause the passage forming unit 16 to be joined the case head 20, thereby forming a major section (see FIG. 7(b)) of the ink jet recording head 10 (see FIG. 1).

When pressure is put to form the major section of the ink jet recording head 10 (see FIG. 1), the burr 14a of the nozzle plate 14 are oriented toward the metal plate 81, and the burr 14a are in contact with the sheet 91, thereby allowing the joining of the nozzle plate 14 to the passage forming substrate 12 to be maintained in a uniform manner.

Although the embodiment above is described using the ink jet recording head 10 as a liquid ejecting head, the manufacturing method according to the present invention can be applied to the manufacturing of a liquid ejecting head that ejects a liquid other than an ink. Liquid ejecting heads to which the manufacturing method is applicable include various types of recording heads for use in an image recording apparatus such as a printer, a color material ejecting head for use in the manufacture of a color filter such as a liquid crystal display, an electrode material ejecting head for use in the electrode formation of an organic light emitting (EL) display, a field emission display (FED), or the like, and a bioorganic compound ejecting head for use in biochip fabrication.

By incorporating a liquid ejecting head manufactured by this manufacturing method, the liquid ejecting apparatus will provide a high reliability.

1. A manufacturing method of a liquid ejecting head which includes a first substrate having a pressure generating chamber formed therein and a second substrate having a nozzle opening formed therein, the second substrate having a burr resulting from press working formed on one side thereof, comprising:
a first joining step of joining the first substrate to the other non-burred side of the second substrate; and
a second joining step of disposing a sheet for protecting the shape of the burr on one side of the second substrate and joining the second substrate and the first substrate joined in the first step by holding the first substrate, the second substrate, and the sheet between pressing members in such a manner that the sheet is in contact with the burr.

2. The manufacturing method according to claim 1, further comprising:
disposing a case member on one side of the first substrate, opposite to the side contacting the second substrate, after joining the second substrate to the first substrate to form a joined body; and
joining the joined body to the case member by performing pressing with the joining jig.

3. The manufacturing method according to claim 1, wherein the sheet is a sheet made of fluorine resin (polytetrafluoroethylene (PTFE)) consisting of fluorine and carbon.

4. A liquid ejecting apparatus comprising the liquid ejecting head fabricated by the manufacturing method according to claim 1.
